(19) United States
(12) Patent Application Publication
(10) Pub. No.: US 2023/0394594 A1
(43) Pub. Date: Dec. 7, 2023

(54) Influencer Tracking and Rating System

(71) Applicant: Allon Caidar, San Diego, CA (US)

(72) Inventor: Allon Caidar, San Diego, CA (US)

(21) Appl. No.: 17/832,030

(22) Filed: Jun. 3, 2022

(51) Int. Cl. G06Q 50/00; G06Q 30/02

(52) U.S. Cl. CPC G06Q 50/01; G06Q 30/0282

(57) ABSTRACT

A computer-implemented system for identifying, tracking and rating product influencers to social media users is provided. The system provides product sellers the ability to search for and choose product influencers to produce and communicate media relating to the product to social media users. Influencers can be ranked based on total sales to a storefront of the seller which hosts the media associated with the seller product.

### BACKGROUND OF THE INVENTION

### 1. Field of the Invention

The invention herein disclosed relates generally to the field of advertising and sales of products. More particularly, it relates to a system for providing the identification and ranking of social media influencers relating to particular product sales in combination with a tracking system for rating sales results associated with each influencer which is accessible by advertisers.

### 2. Prior Art

The marketing of products through the employment of internet accessed product-related videos has become ever more prevalent with the maturing internet and the increasing number of internet and broadcast media channels. This visual marketing has increased exponentially with the advent of increased network bandwidth which can be accessed by smartphones, pad computers, and the like having video displays and audio capable of remotely depicting product video advertising.

In recent years, such product video marketing has evolved to include social media influencer marketing, also known as influence marketing. Influencer marketing, as a version of social media marketing, includes personal endorsements and product and service placement originated by influencers. Such influencers are generally people and organizations who have a known or a purported expert level of knowledge of certain products or services or a certain social influence in their purported field.

As a consequence, such social media influencers have become sought after by product and service sellers since they have become known to have the power to affect the buying habits or quantifiable actions of buyers. These influencers accomplish this influencing of others by publishing videos relating to the products or services for which they have become known. Such internet published videos are generally in the form of original content which is either pushed or made accessible to users of social media platforms such as Instagram, YouTube, Snapchat or other online channels.

In a general sense, such influencer marketing occurs when a product seller, having a product or brand, secures the services of an influencer who has a generally recognized level of credibility in the product or service being sold. Additionally, sellers will choose a particular influencer based on the audience on social media platform which they have become known to discuss or mention the brand in a social media post which will frequently include a product or service related video link.

However, there is little or no manner for sellers of products to ascertain if a hired influencer has or will actually result in product or service sales to their audience. Further, for companies wanting to hire an influencer for product or service promotion, there is a lack of a system which will allow companies selling products and services to review and choose an influencer from an available group by the product or service the company sells, which is associated with an influencer who has a reasonable success rate for promotion of such.

With respect to the above, before explaining at least one preferred embodiment of the system herein which provides an influencer and product association system, and rating system for influencers, it is to be understood that the system herein is not limited in its application to the details of employment and to the arrangement of the components or the steps set forth in the following description or illustrated in the drawings. The various software-enable methods and steps of the herein disclosed invention for providing a product association with influencers and a rating system for such influencers is capable of other embodiments, and of being practiced and carried out in various ways, all of which will be obvious to those skilled in the art once the information herein is reviewed.

Also, it is to be understood that the phraseology and terminology employed herein are for the purpose of description and should not be regarded as limiting. As such, those skilled in the art will appreciate that the conception upon which this disclosure is based may readily be utilized as a basis for other influencer product association and rating systems. It is important, therefore, that the embodiments, objects and claims herein, be regarded as including such equivalent construction and methodology insofar as they do not depart from the spirit and scope of the present invention.

### SUMMARY OF THE INVENTION

The disclosed system herein provides a software-enabled system and method for the choosing and rating of individual social media influencers, also known as creators, in relation to a reasonable calculation of actual product or service sales generated by a video or web promotion initiated by each respective influencer. Such promotion may be through a published video created by that influencer which relates to the product or services of a selling user or company securing the services of such an influencer.

The system herein also provides selling users, who are advertisers or companies selling products or services to customers, a system to first identify one or more social media influencers or creators who are associated with or ranked to best promote their respective product or service they wish to sell. Such is accomplished by first assembling a searchable database which identifies individual influencers who are or have associated themselves as promoting respective products and services. Initially influencers can sign on to the system and input their identity, contact information, and the products and/or services which the influencer can or has promoted. Such will allow selling users who subscribe to the system to find influencers in relation to a particular product or service the selling user wishes to promote. Using a database stored in electronic memory, each individual influencer is associated with the products and services for which they have consumer influence. Thus, the subscribing selling users can either search an influencer by name or they can search the database for influencers associated with the product or service the selling user wants to promote to identify potential influencers.

The system will, over time, include rankings associated with each influencer in the relational database as to total sales generated by the media generated and communicated to social media by that influencer. Additionally, the total sales by each respective product or service for which media is communicated by an influencer can also be tracked and ranked. The ranking by each product and service associated with each respective user can be provided to the selling users to allow them to better choose an influencer who has the best success in total sales or ranking for the particular product or service of interest to the selling user.

The system herein thus, in one mode, allows advertisers or selling users for products or services to either choose an influencer by name or identifier or to search all users for those associated with the products or service of the selling user, and then choose an influencer with the best sales totals or ranking for the associated products or services.

Further, the system provides a selling user, who secures a known influencer of such products and services, a manner to ascertain, with some certainty, through the ongoing calculation of a conversion rate or success rate of each influencer, the advertiser will or has used to sell their product or service. Conversely, where an advertiser or selling user for products or services has no chosen influencer for their product or service, the system herein provides such selling users a means for identification of the most appropriate influencers for a particular product or service to be advertised. Such is calculated and provided by determining an association of such products or services to be advertised by an influencer to the one or more influencers having the highest conversion rate of sales from published video ads for such products or services.

In this fashion, advertisers already using a particular influencer can track product or service sales based on the system-ascertained total aggregate sales or success rate for published videos by that influencer for the products or service of that selling user. Where the advertiser has no previous influencer, it allows such a company to query and choose an influencer from the system based on previous success rates for the same or similar products and services associated with each influencer. Once an influencer is chosen, the system will allow the advertiser or company to track a conversion rate for product sales based on product related videos published by that chosen influencer, which result in sales on an influencer storefront, which communicates orders to the selling user. This influencer storefront will allow buyers who know each influencer or have had media communicated to them by that influencer to purchase products from the selling user through the influencer storefront page.

In a step which influencers will find assuring, they will be paid based on the actual results of sales generated through the influencer storefront.

In all modes of the system and steps herein noted, the system provider will employ network accessible computers having accessible electronic memory for storage and retrieval of electronic database information relating to each product, service, and influencer. Software running in electronic memory will operate to input data or information required and function to provide the individual task noted for each step in the system.

As to electronic memory or computer readable media for the system herein, any combination of one or more computer-usable or computer-readable media, be it transitory or non transitory, may be employed for operation of the system herein. Such, for example and in no way limiting, can include computer-readable media and may include one or more of a portable computer diskette, a hard disk, a random access memory device, a read-only memory device, an erasable programmable read-only memory (EPROM or Flash memory) device, a portable compact disc read-only memory device, an optical storage device, and other electronic memory magnetic storage devices. Software or computer program code for carrying out the individual and sequential operations of the present invention may be written in any combination of one or more programming languages.

The steps or method of operation or execution of the various modes of the system herein are illustrated as blocks or steps in the drawings which represent one or more sequences in the operation of the steps in the system herein. These operations or steps can be implemented in hardware, software operating to process input data to accomplish the task or step, or a combination thereof.

With regard to software operating to a task or steps indicated in the system, such represents computer-executable instructions stored upon one or more transitory or non-transitory computer-readable storage media, which, when executed by one or a plurality of processors, will operate to perform the recited operation or step. Computer-executable instructions, in general, include routines, programs, algorithms, data structures, and the like which are configured to perform particular functions or to implement particular abstract data types or steps noted.

It should be noted that the sequence in which the steps of the system herein are described or depicted is not intended to be construed as a limitation. It should be understood that any number of the described or designated steps can be combined in any order and/or in parallel to implement the described and depicted processes. In some modes of the system herein, one or more steps can be rearranged or omitted entirely. Still further, the software-enabled steps in the system herein can be combined in whole or in part with each other or with other steps or methods.

With respect to the above description, before explaining at least one preferred embodiment of the system and method of identifying and rating influencers and for determining influencers most successful in promoting a product or service, it is to be understood that the invention is not limited in its application to the details of operation nor the arrangement of the components or the steps set forth in the following description or illustrations in the drawings. The various methods of implementation and operation of the method herein are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis for designing of methods and systems for rating of influencers and for carrying out the several purposes of the present method. Therefore, that the objects and claims herein should be regarded as including such equivalent construction, steps, and methodology insofar as they do not depart from the spirit and scope of the present invention.

It is an object of this invention to provide a computer-implemented method employing software operating to the task of identifying and tracking influencers and the products and services they promote through influencer videos.

It is a further object of this invention to provide such a an influencer tracking method which also will determine sales and conversion rates attributable to communicated influencer videos to provide a rating for each influencer by each product or service promoted.

It is yet another object of this invention to provide such an influencer product association system which will allow selling companies to query the system to choose an influencer by the product or services promoted, previously, by each respective influencer.

These, together with other objects and advantages, which become subsequently apparent reside in the details of the construction and operation of the influencer tracking and rating system herein as more fully hereinafter described and claimed, reference being had to the accompanying drawings forming a part thereof, wherein like numerals refer to like parts throughout.

Further objectives of this invention will be ascertained by those skilled in the art as brought out in the following part of the specification wherein detailed description is for the purpose of fully disclosing the invention without placing limitations thereon.

### BRIEF DESCRIPTION OF DRAWING FIGURE

FIG. 1 shows a flow chart of the method and system herein.

### DETAILED DESCRIPTION OF THE PREFERRED EMBODIMENTS OF THE INVENTION

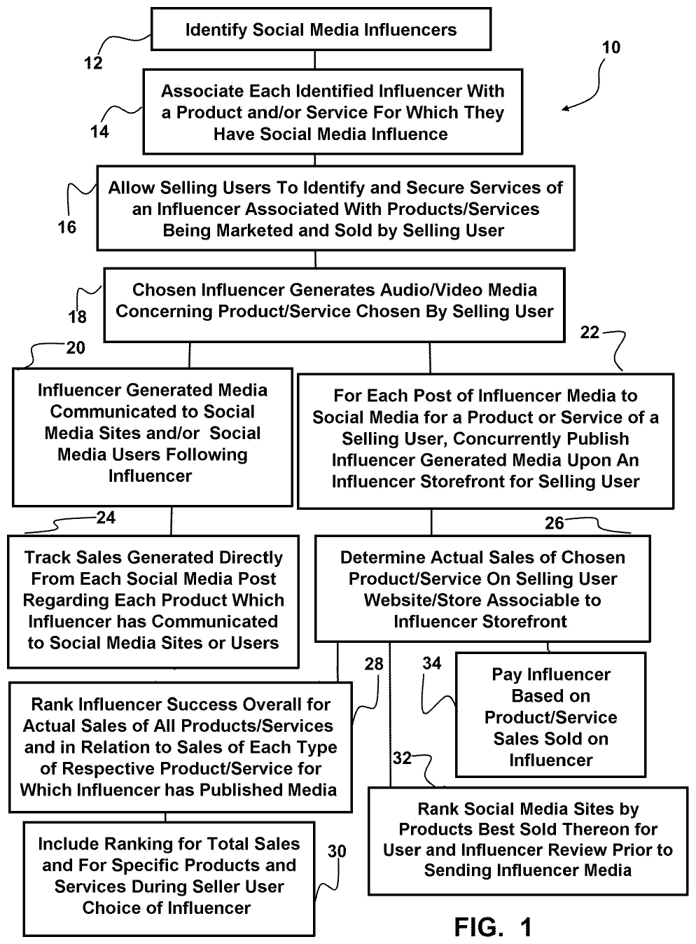

Referring now to the method and system 10 herein shown in simple format by the depictions of FIG. 1, as noted above, software running to perform each step or task in the system 10 will operate on network-connected computers having such software operatively running thereon, wherein selling users and influencers identified and tracked by the system, can access the system 10 over a network, such as the internet.

The influencer rating and identification system 10 herein will identify each influencer 12 identified and tracked by the system 10. Such an identification will, for example, be the name of the influencer and/or the system can assign an influencer identifier to each respective influencer in the form of an influencer identification number or other unique identifier which will be continuously associated with each respective influencer of the system 10.

Initially and on an ongoing basis, influencers can sign up for the system 10 herein using a sign up webpage communicated to the influencer either in hard copy, or preferably, electronically over a network, such as the internet. Thus, the identification of social media influencers 12 will be ongoing and can be input through influencer sign-up or can be input by the system provider using the identification and contact information of known influencers identified by the system provider.

For each individual influencer, so identified 12 and added to a relational database of influencers held in electronic memory of the system, the system 10 will also, on a continuous basis, form a database and store information therein, which will associate each influencer 14 with one or a plurality of respective products or services which the respective influencer identifies or is known to have purchasing influence to users of social media. Such an association of each influencer identifier with a product or service 14 identifier may be accomplished by associating the respective influencer identifier held in the system 10 with respective individual product identifiers, which are or have been previously associated with each respective product or service. Such individual product or service identifiers may be generated in a proprietary fashion and assigned by the provider of the system 10, or the system provider may acquire and use product and service identifiers from other sources, such as the manufactures thereof, or government product and service identifiers, such as from the North American Industry Classification System (NAICS).

As such, in all modes and operations of the system 10, each product or service, promoted by any influencer, is given a unique product identifier that can be associated with each such respective product or service on an ongoing basis for current and future tracking of influencers and their success or sales conversion rate of such products and services. In this fashion, each product or service, for which selling users will secure the services of an influencer to produce and communicate media, such as videos to social media, will have a specific product or service identifier in the system 10, which is associated with it. This product identifier can be associated with the influencers currently promoting it and doing so in the future. This allows the selling users to identify a specific individual influencer 14, by either the influencer name or identifier or by a product identifier, which has been associated with each respective influencer in the system.

With each influencer and each product and/or service all having unique identifiers, which are held in a relational database in electronic memory by the system 10, selling users who subscribe to the system 10 are provided access to the system 10 to secure the services of an influencer 16. The selling user can either identify a specific influencer they wish to use or, as noted herein, they can employ the system 10 to search for products or services to be sold by the advertiser and find the identity of influencers having an influencer identification which has been previously associated with the products and services being sold by the advertiser.

Once the influencer is chosen by the selling user, the influencer will generate media to communicate to social media sites and individual social media users. By media herein is meant videos, audio, or combinations thereof, which relate to the product or services of the selling user 18 which can be transmitted electronically over a network, such as the internet, and played upon the computing device of social media users. By computing device is meant desktop computers, laptop computers, tablet computers, smartphones, and similar computing device which will communicate electronically over a network to receive media generated by influencers and display video and reproduce sound on such computing devices. Conventionally, such influencers are well known to generate videos having an audio track which, when communicated over a network, are playable upon the computer devices of users of social media such as FACEBOOK, TICKTOK, and INSTAGRAM and similar social media sites.

Once the influencer chosen by the selling user has generated the media for the products or services of the selling user choosing them 18, an influencer-generated media post is communicated to or through the provider of the system 10, wherein the system provider will communicate the influencer-generated media post to the social media sites and/or directly to social media users, designated by or who follow the influencer 20, at their electronic address for receipt of such. Concurrently and particularly preferred, in order to best track sales, the same influencer-generated media post is placed on an influencer storefront 22, which is hosted on or in direct communication with the selling website or store of the selling user.

This is an especially preferred step. This is because it may be harder to track each social media post of each influencer to individual social media users, to determine an actual sale of the product or service 24 due to prohibitions on tracking and the like. However, highly accurate sales conversion rates of actual sales to social media users, visiting the influencer storefront 22 which communicates sales to the selling users website 26, is achievable. This is because visitors to the influencer storefront 22 hosting the identical media concerning the products can be identified using conventional means for such. A hot link to the influencer storefront 22 can be included in the media communicated to individual social media users 20, where permitted, or text or audio communicating a manner to connect to the influencer storefront 22 can be included in media communicated to social media users 20. Also, posting the identical influencer generated media 18 concurrently on the influencer storefront, which is communicated to social media users 20, will cause search engines on the Internet to associate the two different locations, making it easy for social media users to find the influencer storefront in a simple search engine search by the name of the influencer media clip or the influencer. Consequently, the concurrent positioning of the same influencer-generated media is most preferred.

In another step, the system 10 can provide for a success ranking of influencers to the products or service for which they generate and communicate media 28. In determining this success rate for each influencer, the total aggregate number of influencer generated videos or media, which the system provider communicates to social media sites 20 or social media users, can be employed in a calculation with the total aggregate number of purchasing social media users who visit the influencer storefront and purchase the product from the connected or hosted purchasing website of the selling user 26.

For example, for a product or service having a product identifier in the system X/Y=R, where X is the total number of communicated influencer-generated media was sent to social media sites or social media users, relating to that product identifier, and Y is the total number or dollar amount of sales of the product having the product identifier from visitors to the sales website of the selling user. R would thus be a rating number for the respective influencer, who generated and sent the media, for the specific product or service associated with that product identifier, for which the respective influencer generated the media for the selling user.

Thus, a respective influencer my be given a rating or ranking R for that respective influencer for each respective individual product or service having the product identifier on the system, for which that influencer generated media content and sent such to social media users. This influencer rating, as associated with specific products or services having system associated specific product and service identifiers, will allow the system 10 to provide selling users choosing an influencer 16 the ability to search for a ranking of each influencer 30, by specific products and services, and choose one.

For selling users who already have an influencer identified, who is on the system 10 whom they use to generate media, they now can track a conversion rate or sales rate for each such influencer and the specific influencer-generated media which they sent to social media sites and users, and concurrently posted on the influencer storefront 22, which takes orders for the selling user. For selling users, who do not have an influencer chosen, in a particularly preferred step in the system 10, they can search for the most effective influencer by the ranking of sales 30, registered on the system 10, which is associated with each influencer. Instead of searching for a known influencer, the selling user can search the system for the product identifier of their product or service, and then view the influencers on the system 10 who have the highest ranking 30 for the product or service of the selling user during the securing step 16.

In another provided step to selling users employing the system 10 herein a ranking of each social media site, with a product success rate for the products or services which are communicated in influencer generated media to such social media sites, can be determined and provided in a ranking of social media sites by product 32. As noted above, where X is the total number of influencer videos or media sent to all social media users relating to the product identifier of a product or service, the number of influencer generated videos yielding a response from social media users to each individual social media site, can be determined. By response is meant a visitation by a social media user to the influencer storefront on which the same media was concurrently posted. Thus, a communicated number of such videos (P) as a percentage of X will be attributed to each individual social media site, where an influencer-generated media is communicated.

The social media site with the highest number of social media users, who communicate onto the influencer storefront, can be identified and each social media website can be rated for both each individual influencer, and each product for which they generated media and sent it to social media users.

The respective total tracking number of social media users from each respective social media site, who input interest about the product by simply visiting the influencer storefront, can be tracked and determined by the system provider. Thus, each social media site can be rated for response to the media generated by an influencer and for the actual products based on the most visits to the influencer storefront. A ranking of the individual social media sites, for specific products 30 having the product identifier on the system, can be determined from the number of individual social media users from each respective social media site who visit the influencer storefront.

Thus, prior to the system provider communicating an influencer generated video or other media to social media site user, the system allows both the influencers and the selling users, the ability to search for the best social media sites to send the new influencer-generated media. This can be determined by searching the product identifier of the current product or service which is the subject of the influencer generated media, to find which social media website previously yielded the highest ranking for that product or service, based on the number of visits of respective social media users, from each respective social media site, to the influencer storefront.

This ability to rank social media sites by products best sold thereon 30 will provide an additional manner for selling users to have the system provider communicate their influencer generated videos or media to the social media sites showing the best ranking for the product which is the subject of the influencer generated video or media.

In another preferred step in the system 10, based on the determined actual sales through the influencer storefront 26, the payment due the influencer can be determined 34 and the influencer can be paid by either the system provider or by the selling users.

While all of the fundamental characteristics and features of the influencer tracking and rating system have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A computer-implemented method for tracking and rating influencers, the method comprising the steps of:
identifying a group of individual social media influencers;
associating each individual social media influencer with at least one product for which they influence buyers;
having sellers identify a chosen influencer from said group of social media influences to provide influencing services for a seller product;
having said chosen influencer generate influencer media relating to said seller product;
communicating said influencer media to social media users of individual social media sites who are following said chosen influencer, and concurrently posting said influencer media to a storefront of said seller which is associated with said chosen influencer;
determine actual sales of said seller product occurring on said storefront of said seller which is associated with said chosen influencer; and
from said actual sales calculating a payment amount to be tendered to said chosen influencer.

2. The computer-implemented method of claim 1, also including:
determining a number of said social media user to which said influencer media was communicated;
determining an influencer ranking for said chosen influencer by dividing said actual sales by said number of social media users to which said influencer media was communicated;
associating said influencer ranking with said chosen influencer; and
providing said influencer ranking associated to each respective influencer, to said sellers for review when they identify a chosen influencer;

3. The computer-implemented method of claim 1, also including:
associating a product type to each seller product;
determining a product type ranking for each said chosen influencer from said actual sales of said seller product associated with said seller product; and
providing said product type ranking associated to each respective influencer, to said sellers for review when they identify a chosen influencer.

4. The computer-implemented method of claim 2, also including:
associating a product type to each seller product;
determining a product type ranking for each said chosen influencer from said actual sales of said seller product associated with said seller product; and
providing said product type ranking associated to each respective influencer, to said sellers for review when they identify a chosen influencer.

5. The computer-implemented method of claim 2, also including:
determining which respective social media site has linked buyers to a visit to said storefront of said seller which is associated with said chosen influencer;
determining an influencer site ranking for each respective social media site based upon a total number of visits to said storefront of said seller which is associated with said influencer;
associating said influencer site ranking to the chosen influencer; and
providing said influencer site ranking associated to each chosen influencer to said sellers for review when they identify a chosen user.

6. The computer-implemented method of claim 3, also including:
determining which respective social media site has linked buyers to a visit to said storefront of said seller which is associated with said chosen influencer;
determining an influencer site ranking for each respective social media site based upon a total number of visits to said storefront of said seller which is associated with said influencer;
associating said influencer site ranking to the chosen influencer; and
providing said influencer site ranking associated to each chosen influencer to said sellers for review when they identify a chosen user.

7. The computer-implemented method of claim 4, also including:
determining which respective social media site has linked buyers to a visit to said storefront of said seller which is associated with said chosen influencer;
determining an influencer site ranking for each respective social media site based upon a total number of visits to said storefront of said seller which is associated with said influencer;
associating said influencer site ranking to the chosen influencer; and
providing said influencer site ranking associated to each chosen influencer to said sellers for review when they identify a chosen user.
